(19) United States
(12) Patent Application Publication
(10) Pub. No.: US 2015/0365894 A1
(43) Pub. Date: Dec. 17, 2015

(54) METHODS AND APPARATUSES FOR DISCONTINUOUS RECEPTION

(71) Applicants: Wei BAI, Chaoyang District, Beijing (CN); Jing HAN, Chaoyang District, Beijing (CN); Haiming WANG, Chaoyang District, Beijing (CN); Xinying GAO, Chaoyang District, Beijing (CN); Lili ZHANG, Haidian District, Beijing (CN); Pengfei SUN, Tongzhou District, Beijing (CN); BROADCOM CORPORATION, Irvine, CA (US)

(72) Inventors: Wei Bai, Beijing (CN); Jing Han, Beijing (CN); Haiming Wang, Beijing (CN); Xinying Gao, Beijing (CN); Lili Zhang, Beijing (CN); Pengfei Sun, Beijing (CN)

(21) Appl. No.: 14/442,318

(22) PCT Filed: Nov. 22, 2012
(86) PCT No.: PCT/CN2012/085056

§ 371 Date: May 12, 2015

(51) Int. Cl. H04W 52/02; H04L 1/18

(52) U.S. Cl. CPC H04W 52/0216; H04L 1/1854

(57) ABSTRACT

A method, apparatus and computer program product are provided for minimizing power consumption in a macro cell. A method and apparatus may establish a dual connection with a local area access point of a local area cell and a macro access point of a macro cell. The method and apparatus may also enter a power save mode in a macro cell by utilizing a first discontinuous reception (DRX) pattern in the macro cell in response to establishing the dual connection. The first DRX pattern may include a designated DRX active time period in which a communication device is designated to be active. The DRX active time period is aligned with a time period of a paging occasion of the apparatus.

### TECHNOLOGICAL FIELD

Embodiments of the present invention relate generally to wireless communication technology and, more particularly, to a method, apparatus and computer program product for managing discontinuous reception operation in a dual connection communications system.

### BACKGROUND

Due to increases in the demand for wireless Internet access, demands on wireless networks, such as cellular networks, are expected to soar in the foreseeable future. Among one of the most promising strategies for satisfying this rapidly increasing demand involves dual connection, which incorporates local area (LA) networks into broader network infrastructure.

Currently, “dual connection” also referred to as inter-enhanced Node B Carrier Aggregation (inter-eNB CA), multi-stream connection, etc. has recently emerged as a way to incorporate LAs into cellular networks. The targeted scenario is to enable user equipment (UE) to connect to both a macro evolved Node B (eNB) (e.g., operating on a 2 GHz frequency band) and a LA eNB (e.g., operating on a 3.5 GHz frequency band) simultaneously, with the macro eNB controlling some connection and signalling aspects, such as mobility functions, while the LA eNB offloads most data transmission. This allows the UE to benefit from the high data rate and low required transmission power provided by the LA cell due to its small distance.

For example, one of the attractive properties of the 3.5 GHz frequency band is that there may be up to 100 MHz continuous frequency resources. As such, a very likely operation involving dual connection is to only use a macro access point to transmit some important C-plane signalling, but use the LA eNB to transmit almost all the traffic. Besides the abundant frequency resource, there are also other benefits in an instance in which a UE routes the traffic on the LA eNB on the 3.5 GHz frequency band.

For example, this may reduce the power consumption of a UE because the UE may have a better channel quality to the LA eNB with small pathloss. Additionally, this may improve the spectrum efficiency by a higher reuse factor.

Although there is a benefit in an instance in which a UE transmits/receives most of the traffic via a LA eNB, there may still be some signalling that should be transmitted via the macro eNB due to the wider coverage and mobility demand provided by the macro eNB. For example, paging may typically be transmitted via the macro eNB to reduce the paging overhead by the wider coverage. In addition, system information, handover commands, measurements report, Radio Resource Control (RRC) connectionReconfiguration signalling may typically be transmitted via the macro eNB.

Another consideration is that UE may need to have two radio frequency (RF) chains to support the dual connection operation because the macro cell and LA cell may operate on two far away frequency bands (e.g., a 2 GHz frequency band for the macro eNB and a 3.5 GHz frequency band for the LA eNB) and the radio frequency retuning may be not fast enough to support a Time Divide Multiplexing (TDM) solution.

Although dual connection provides many benefits in the evolution of cellular networks such as Long Term Evolution (LTE) networks there may be increased energy consumption by the UE due to the UE operating in both the macro cell and the LA cell. Currently, in a LTE system, Discontinuous Reception (DRX) is typically a mechanism that is utilized to provide efficient energy consumption. However, currently in dual connection since most of the traffic is routed via the LA cell there is no suitable manner in which to reduce the power consumption on the macro cell.

### BRIEF SUMMARY

A method, apparatus and computer program product are therefore provided in accordance with an example embodiment to minimize the power consumption on a macro cell in a dual connection communications system. In an example embodiment, user equipment (UE) (e.g., a mobile terminal) may be connected simultaneously to a macro access point (e.g., a macro evolved Node B (eNB)) of a macro cell and a local area access point (e.g., a local eNB) of a local area cell. In this example embodiment, mobility information may be controlled and transmitted via the macro access point. On the other hand, traffic data may be routed via the local area access point. Since most of the traffic data may be routed via the local area access point, an example embodiment may reduce or minimize the power consumption of the macro cell.

In this regard, an example embodiment may utilize two sets of Discontinuous Reception (DRX) configurations that are configured for dual connection capable UEs. For example, in response to establishing a dual connection, a UE may enter a power saving mode in the macro cell, and the UE may monitor a fixed subframe pattern in which there may be important control information, system information, paging information as well as other information. On the other hand, the UE may switch to and utilize a backup/normal DRX configuration which may consume more power when certain conditions are detected (e.g., the UE loses a connection to the local area cell, the UE is being handed over to another local area cell, etc.).

As such, an example embodiment, may allow a UE to have efficient power consumption in the macro cell similar to an IDLE mode when dual connection is established. An example embodiment may also ensure transmission performance in an instance in which the UE loses a connection from a local area cell by allowing the UE to remain connected to the macro cell when the connection to the local area cell is lost.

In one example embodiment, a method is provided that includes establishing a dual connection with a local area access point of a local area cell and a macro access point of a macro cell. The method of this embodiment also enters a power save mode in a macro cell by utilizing a first discontinuous reception (DRX) pattern in the macro cell in response to the establishing of the dual connection. The first DRX pattern may include a designated DRX active time period in which a communication device is designated to be active. The DRX active time period may be aligned with a time period of a paging occasion of the communication device.

In another example embodiment, an apparatus is provided that includes at least one processor and at least one memory including computer program code with the at least one memory and the computer program code being configured to, with the processor, cause the apparatus to at least establish a dual connection with a local area access point of a local area cell and a macro access point of a macro cell. The at least one memory and the computer program code of this embodiment are also configured to, with the processor, cause the apparatus to enter a power save mode in a macro cell by utilizing a first discontinuous reception pattern in the macro cell in response to the establishing of the dual connection. The first DRX pattern may include a designated DRX active time period in which the apparatus is designated to be active. The DRX active time period may be aligned with a time period of a paging occasion of the apparatus.

In a further example embodiment, a computer program product is provided that includes at least one computer-readable storage medium having computer-readable program instructions stored therein with the computer-readable program instructions including program instructions configured to establish a dual connection with a local area access point of a local area cell and a macro access point of a macro cell. The computer-readable program instructions of this embodiment also include program instructions configured to enter a power save mode in a macro cell by utilizing a first discontinuous reception pattern in the macro cell in response to the establishing of the dual connection. The first DRX pattern may include a designated DRX active time period in which a communication device is designated to be active. The DRX active time period may be aligned with a time period of a paging occasion of the communication device.

In another example embodiment, an apparatus is provided that includes means for establishing a dual connection with a local area access point of a local area cell and a macro access point of a macro cell. The apparatus of this embodiment also includes means for entering a power save mode in a macro cell by utilizing a first discontinuous reception pattern in the macro cell in response to the establishing of the dual connection. The first DRX pattern may include a designated DRX active time period in which the apparatus is designated to be active. The DRX active time period may be aligned with a time period of a paging occasion of the apparatus.

In yet another example embodiment, a method is provided that includes detecting that a communication device establishes a dual connection with a local area access point of a local area cell and a macro access point of a macro cell. The method of this embodiment also includes configuring a power save mode by generating a first discontinuous reception pattern in response to aligning a time period of a paging occasion of the communication device with a designated DRX active time in which the communication device is designated to be active upon detecting that the communication device established the dual connection. The method of this embodiment also includes enabling provision of the first DRX pattern to the communication device to enable the communication device to enter the power save mode and utilize the first DRX pattern in the macro cell.

In a further example embodiment, an apparatus is provided that includes at least one processor and at least one memory including computer program code with the at least one memory and the computer program code being configured to, with the processor, cause the apparatus to at least detect that a communication device establishes a dual connection with a local area access point of a local area cell and a macro access point of a macro cell. The at least one memory and the computer program code of this embodiment are also configured to, with the processor, cause the apparatus to configure a power save mode by generating a first discontinuous reception pattern in response to aligning a time period of a paging occasion of the communication device with a designated DRX active time in which the communication device is designated to be active upon detecting that the communication device established the dual connection. The at least one memory and the computer program code of this embodiment are also configured to, with the processor, cause the apparatus to enable provision of the first DRX pattern to the communication device to enable the communication device to enter the power save mode and utilize the first DRX pattern in the macro cell.

In another example embodiment, a computer program product is provided that includes at least one computer-readable storage medium having computer-readable program instructions stored therein with the computer-readable program instructions including program instructions configured to detect that a communication device establishes a dual connection with a local area access point of a local area cell and a macro access point of a macro cell. The computer-readable program instructions of this embodiment also include program instructions configured to configure a power save mode by generating a first discontinuous reception pattern in response to aligning a time period of a paging occasion of the communication device with a designated DRX active time in which the communication device is designated to be active upon detecting that the communication device established the dual connection. The computer-readable program instructions of this embodiment also include program instructions configured to enable provision of the first DRX pattern to the communication device to enable the communication device to enter the power save mode and utilize the first DRX pattern in the macro cell.

In another example embodiment, an apparatus is provided that includes means for detecting that a communication device establishes a dual connection with a local area access point of a local area cell and a macro access point of a macro cell. The apparatus of this embodiment also includes means for configuring a power save mode by generating a first discontinuous reception pattern in response to aligning a time period of a paging occasion of the communication device with a designated DRX active time in which the communication device is designated to be active upon detecting that the communication device established the dual connection. The apparatus of this embodiment also includes means for enabling provision of the first DRX pattern to the communication device to enable the communication device to enter the power save mode and utilize the first DRX pattern in the macro cell.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a diagram of a system according to an example embodiment of the invention;

FIG. 2 is a schematic block diagram of an apparatus from the perspective of a base station in accordance with an example embodiment of the invention;

FIG. 3 is a block diagram of an apparatus from the perspective of a terminal in accordance with an example embodiment of the invention;

FIG. 4 is a diagram of a system according to an example embodiment of the invention;

FIG. 5 is a diagram of a paging frame according to an example embodiment of the invention;

FIG. 6 is a flowchart for minimizing power consumption in a macro cell according to an example embodiment; and

FIG. 7 is a flowchart for reducing power consumption in a macro cell according to another example embodiment.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As noted in the Background section, dual connection is a promising solution to enhancing wireless network capacity and robustness by enabling a UE to simultaneously connect to a local area cell and a macro cell. However, since dual connection enables the UE to be connected to the local area cell and the macro cell at the same time, the UE may consume a high level of power. In current LTE systems, Discontinuous Reception (DRX) is utilized as a mechanism to provide efficient energy consumption. For instance, currently Discontinuous Reception facilitates turning off of a mobile radio receiver and entering a low power state when the mobile device does not expect to receive incoming messages. The mobile radio of the mobile device may wake up during scheduled periods to look for messages. In this manner, the existing DRX mechanism may be utilized to reduce power consumption. However, at present, the existing DRX mechanism is typically designed for a single connection between the UE and a source cell (e.g., the local area cell).

Once dual connection is established, the UE may receive important control signaling from the macro cell, and may transmit/receive most of the traffic from the local area cell. However, at present there is no suitable manner in which to ensure that an active time of a UE's DRX is always aligned with a subframe in which the UE is assigned to be active to receive important information (e.g., paging information). For instance, when performing DRX, an eNB may configure DRX cycle length and related offset, an on_durationTimer, a drx-inactivityTimer, etc., but some of the important information (e.g., paging information, system information, etc.) may have their own reception pattern which is not entirely controlled by DRX and as such may not be aligned with the active time of the DRX.

As such, a problem exists in that although the UE has almost no traffic transmitting from the macro cell (for example, from this perspective, the UE is similar to being in an IDLE state in the macro cell), the UE may need to maintain the connectivity to macro cell for mobility purposes, and this may cause undesirable power consumption from the perspective of the UE. In other words, UE appears to be in a Radio Resource Control (RRC) connected state with respect to the UE power consumption, although the UE is actually in a RRC IDLE state. For instance, there are two DRX states of RRC, such as the DRX RRC Connected state and the DRX RRC IDLE state. In the DRX RRC Connected state, the UE typically has to be more active as compared to the DRX RRC IDLE state. For instance, in the DRX RRC Connected state, the UE may have to awake to monitor all of the possible data transmissions. However, in the DRX RRC IDLE state, the UE may only need to monitor paging information.

Since dual connection enables most of the traffic to be routed via a local area cell, the exemplary embodiments provide a manlier in which to reduce the power consumption on a macro cell.

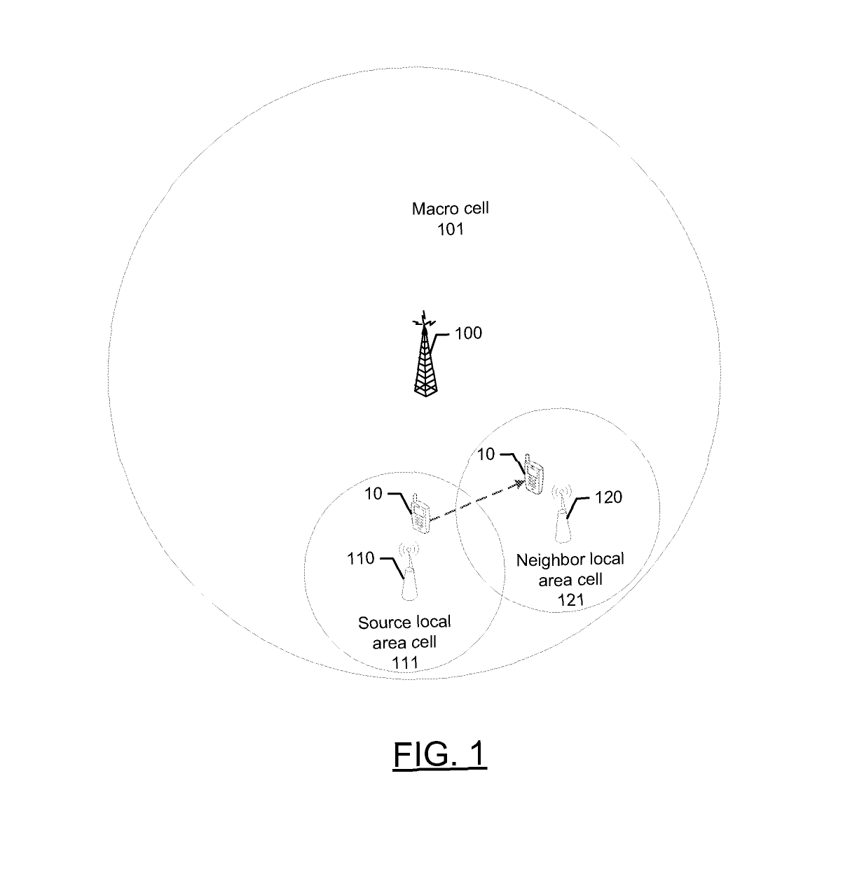

Referring now to FIG. 1, a system supporting dual connection is depicted. As depicted, during dual connection a UE, such as UE 10, may initially be in communication with, e.g., connected to, both a macro access point (MAP) 100 (also referred to herein as a macro eNB 100), which serves a macro cell 101, and a source local area access point (LAAP) 110 (also referred to herein as local eNB 110), which supports a source local area cell 111. As shown, a macro cell may cover a larger area than local cells, and may even overlap with or encompass one or more local cells. In some example embodiments, the UE 10 may be handed over from the source LAAP 110 to a neighbor LAAP 120 (also referred to herein as neighbor eNB 120). For instance, as shown, the UE 10 may move out of range of the source local area cell 111 and into range of the neighbor, e.g., a target, local area cell 121, served by the neighbor, e.g., target, LAAP 120, which may require that the UE 10 be handed over from, the source LAAP 110 to the neighbor LAAP 120 (e.g., the solid-line depiction of UE 10 depicts its initial location in space, movement in space is depicted via a dashed arrow, and the dotted-line depiction of UE 10 depicts its end location). The system depicted in FIG. 1 may support communications between a user equipment, such as the user equipment 10, and a network, such as a Universal Mobile Telecommunications System (UMTS) network, a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a Frequency-Division Multiplexing (FDM) network, e.g., an Orthogonal Frequency-Division Multiplexing (OFDM) network, a General Packet Radio Service (GPRS) network or other type of network, via one or more access points 100, 110, and 120.

As used herein, an access point may refer to any communication device which provides connectivity to a network, such as a base station, an access node, or any equivalent, such as a Node B, an eNB, a relay node, or other type of access point. The term “user equipment” (UE) includes any mobile communication device such as, for example, a mobile phone, portable digital assistant (PDA), pager, laptop computer, a tablet computer, or any of numerous other hand held or portable communication devices, computation devices, content generation devices, content consumption devices, data card, Universal Serial Bus (USB) dongle, or combinations thereof. The communications between the UE 10 and any of access points 100, 110, or 120 may include the transmission of data via an uplink/downlink that is granted between the UE 10 and access points 100, 110 or 120. In the example embodiment of FIG. 1, the UE 10 may be connected to the macro access point 100 and the local access point 110 simultaneously in a dual connection. The macro access point 100 may provide and control mobility while the local access point 110 may offload traffic data. For instance, in some example embodiments, the macro access point 100 may transmit signaling information (e.g., C-plane signaling information, control information, etc.) and the local access point 110 may transmit traffic data. In some other example embodiments, the macro access point 100 may facilitate provision of traffic data. For example, in an instance in which the UE 10 loses a connection to the local access point 110, the UE 10 may remain connected to the macro access point 100 which may facilitate provision of the traffic data since the connection to the local area cell 111 may be lost.

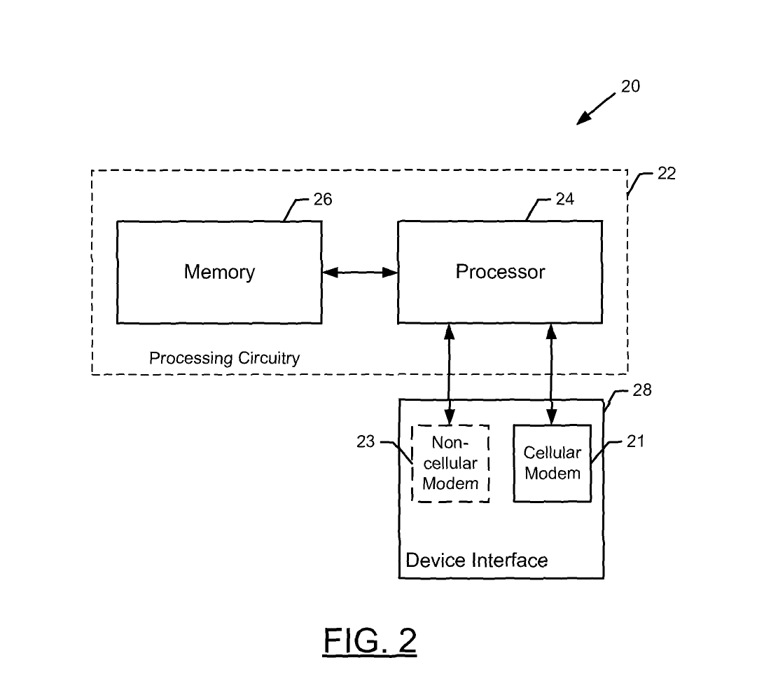

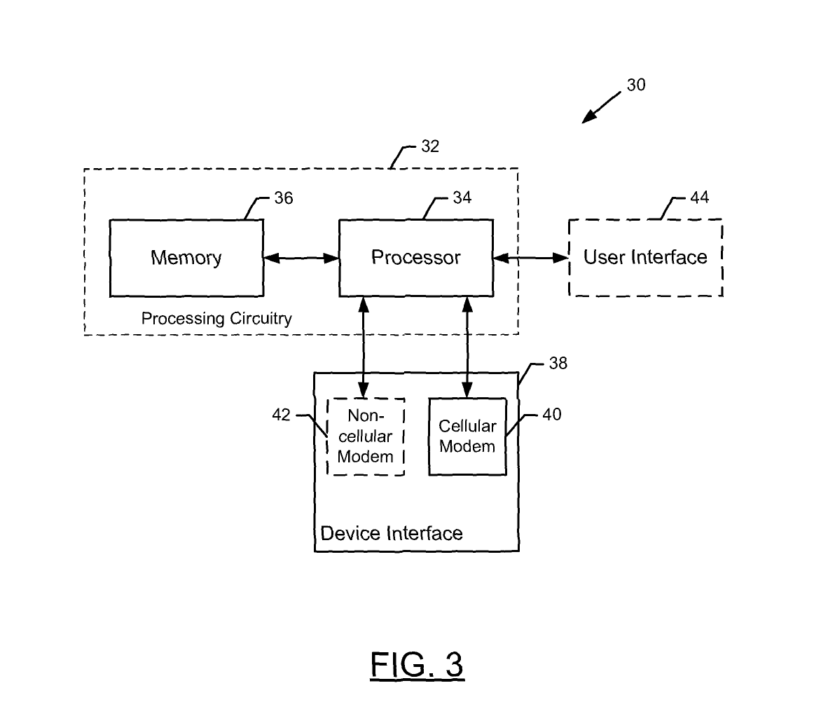

The access points 100, 110, or 120 may embody or otherwise be associated with an apparatus 20 that is generally depicted in FIG. 2 and the user equipment 10 may embody or otherwise be associated with an apparatus 30 that is generally depicted in FIG. 3 which may be configured in accordance with an example embodiment of the present invention as described below. However, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the invention. In some example embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28. As such, the processing circuitry may be embodied as a circuit chip (e.g., an integrated circuit chip) configured (e.g., with hardware, software or a combination of hardware and software) to perform operations described herein in relation to the macro eNB 100, local eNB 110, neighbor eNB 120.

The device interface 28 may include one or more interface mechanisms for enabling communication with other devices, such as one or more UEs 10. In some cases, the device interface may be any means such as a device or circuitry embodied in either hardware, or a combination of hardware and software that is configured to receive and/or transmit data from/to a network and/or any other device or module in communication with the processing circuitry 22. In this regard, the device interface may include, for example, an antenna (or multiple antennas) and supporting hardware and/or software for enabling communications with a wireless communication network and/or a communication modem, such as a cellular modem 21 (e.g., a UMTS modem, a LTE modem, a mobile phone, etc.), and/or an optional non-cellular modem 23 (e.g., a WiFi modem, WLAN modem, etc.) for enabling communications with other terminals (e.g., WiFi terminals, WLAN terminals, APs, etc.).

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

In one embodiment, the UE(s) 10 may be embodied as or otherwise include an apparatus 30 as generically represented by the block diagram of FIG. 3. In this regard, the apparatus may be configured to provide for communications with the macro eNB 100, the local eNB 110, the neighbor eNB 120 or another terminal(s) via a communications system (e.g., a LTE system). While the apparatus may be employed, for example, by user equipment (e.g., a mobile terminal), it should be noted that the components, devices or elements described below may not be mandatory and thus some may be omitted in certain embodiments. Additionally, some embodiments may include further or different components, devices or elements beyond those shown and described herein.

As shown in FIG. 3, the apparatus 30 may include or otherwise be in communication with processing circuitry 32 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include a processor 34 and memory 36 that may be in communication with or otherwise control a device interface 38 and, in some cases, a user interface 44. As such, the processing circuitry may be embodied as a circuit chip (e.g., an integrated circuit chip) configured (e.g., with hardware, software or a combination of hardware and software) to perform operations described herein. However, in some embodiments taken in the context of the user equipment, the processing circuitry may be embodied as a portion of a mobile computing device or other mobile terminal.

The optional user interface 44 may be in communication with the processing circuitry 32 to receive an indication of a user input at the user interface and/or to provide an audible, visual, mechanical or other output to the user. As such, the user interface in the context of a mobile terminal may include, for example, a keyboard, a mouse, a joystick, a display, a touch screen, a microphone, a speaker, and/or other input/output mechanisms.

The device interface 38 may include one or more interface mechanisms for enabling communication with other devices and/or networks. In some cases, the device interface may be any means such as a device or circuitry embodied in either hardware, or a combination of hardware and software that is configured to receive and/or transmit data from/to a network and/or any other device or module in communication with the processing circuitry 32. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In the illustrated embodiment, for example, the device interface includes a cellular modem 40 (e.g., a LTE modem, a UMTS modem, a mobile phone, etc.) for supporting communications with the local eNB 110, the macro eNB 100 and/or neighbor eNB 120 and an optional non-cellular modem 42 (e.g., a WiFi modem, WLAN modem, Bluetooth (BT) modem, etc.) for supporting communications with other terminals (e.g., a WiFi station(s), a WLAN station(s)), etc.).

In an example embodiment, the memory 36 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC, an FPGA or the like. In an example embodiment, the processor may be configured to execute instructions stored in the memory 36 or otherwise accessible to the processor. As such, whether configured by hardware or by a combination of hardware and software, the processor may represent an entity (e.g., physically embodied in circuitry in the form of processing circuitry 32) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

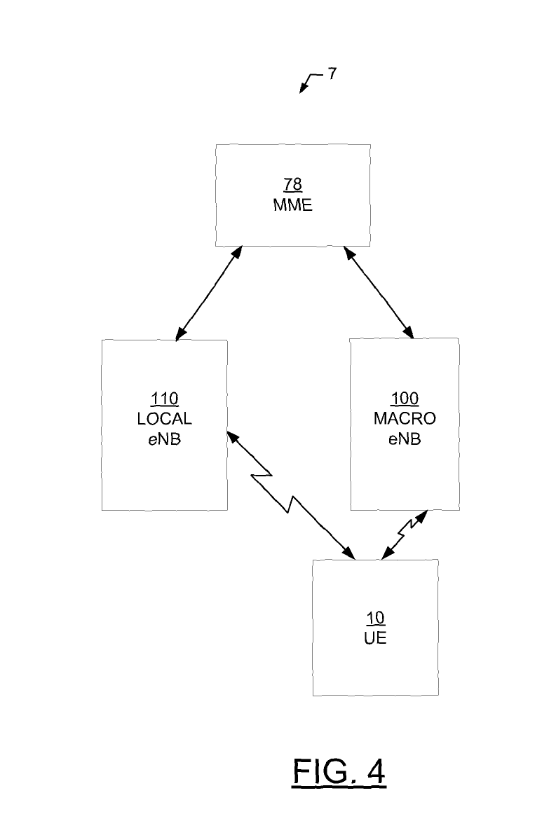

Referring now to FIG. 4, a diagram illustrating a system according to an exemplary embodiment is provided. The system 7 of FIG. 4 includes the local eNB 110, the macro eNB 100 and the UE 10 described above with respect to FIG. 1 as well as a Mobility Management Entity (MME) 78. In some example embodiments, the neighbor eNB 120 may also be included in the system 7. Although the system 7 shows one UE 10, one macro eNB 100 and one local eNB 110, the system 7 may include any suitable number of UEs 10, macro eNBs 100 and local eNBs 110s without departing from the spirit and scope of the invention.

The MME 78 may have a respective apparatus, such as the apparatus 20 depicted in FIG. 2, embodied by or otherwise associated therewith, and including means, such as processing circuitry 22, the processor 24, the memory 26, the device interface 28 or the like, for carrying out the operations of the MME 78 as described herein.

The MME 78 may host functions such as distribution of messages to respective eNBs (e.g., macro eNB 100, local eNB 110), security control, idle state mobility control, Evolved Packet System (EPS) bearer control, ciphering and integrity protection of (non-access stratum) NAS signaling, and the like. Additionally, the MME 78 may allocate and maintain identifiers of UEs. In this regard, the MME 78 may inform the macro eNB 100 of a UE identifier(s) (ID(s)) of the UE 10 and the macro eNB 100 may utilize the UE ID, in part, to calculate a paging occasion of the UE 10, to enable the macro eNB to determine the active time of the UE 10, as described more fully below.

In the example embodiment of FIG. 4, two sets of DRX configurations may be configured for the dual connection capable UE 10. Once dual connection is established by the UE 10 with the macro eNB 100 and the local eNB 110, the UE 10 may enter a power saving mode (also referred to herein as “DRX pattern-1”) in macro cell 101, and may monitor a fixed subframe pattern in which there may be important control information or other information (e.g., system information, paging information, etc.). In one example embodiment, the UE 10 may switch from DRX pattern-1 and may utilize another backup/normal DRX configuration (e.g., a DRX RRC Connected State) (also referred to herein as DRX pattern-2) in response to detection of some conditions, as described more fully below.

To implement the power saving DRX pattern (e.g., DRX pattern-1) on the macro cell, the macro eNB 100 may align the paging occasion of the UE 10 and an active time of the DRX together to enable the UE 10 to be in active time (e.g., for monitoring paging information as well as receipt of other information (e.g., control information, system information)) in the paging occasion (or a paging frame) of the UE 10.

Once dual-connection is established, the MME 78 may inform the macro eNB 100 about the UE ID(s) of the UE 10 which the macro eNB 100 may utilize to calculate the paging occasion of the UE 10. In response to calculating the paging occasion of the UE 10, the macro eNB 100 may determine the active time of the UE 10. The active time of the UE may be a time period in which the UE 10 is assigned to monitor or receive information (e.g., system information, control information, etc.) as designated by the paging occasion. In response to determining the active time associated with the paging occasion of the UE 10, the macro eNB 100 may send the UE 10 an indication instructing the UE 10 to align the paging occasion with the DRX active time.

In an example embodiment, the power consumption of the DRX pattern-1 may be analogous to a DRX for an RRC IDLE state wherein in an instance in which a UE 10 is in IDLE mode, the UE 10 monitors paging information, during a time period associated with a paging occasion and/or paging frame. In one example embodiment, a paging occasion may correspond to a System Frame Number (SFN) of the frame of which a UE (e.g., UE 10) may monitor the channel (e.g., a Paging Indication Channel (PICH)) to determine whether a paging message(s) is being sent to the UE.

The UE 10 may switch to a backup/normal DRX configuration (DRX pattern-2) (e.g., DRX RRC Connected state) under the following conditions. For instance, the UE 10 may switch to and utilize the backup/normal DRX configuration in the macro cell 101 in response to the UE 10 detecting that the UE 10 lost a connection with the local eNB 110 of the local area cell 111. The UE 10 may also switch to and utilize the backup/normal DRX configuration in the macro cell 101 in an instance in which the UE 10 is being handed over from the local area cell 111 to another local area cell (e.g., neighbor local area cell 121). In addition, the UE 10 may also switch to and utilize the backup/normal DRX configuration in the macro eNB 100 in an instance in the UE detects that the dual connection is released by the local eNB 110 or the UE 10. Moreover, the UE 10 may also switch to and utilize the backup/normal DRX configuration in the macro cell 101 in an instance in which the UE 10 is explicitly indicated or informed by the local eNB 110 of the local area cell 111 to utilize the normal DRX configuration.

In some example embodiments, the DRX pattern-2 may correspond to a DRX RRC Connected state of the UE 10 in which the UE 10 may monitor a Physical Downlink Control Channel (PDCCH) for information (e.g., traffic information). In this regard, the DRX RRC Connected State may specify at least one time period that a UE (e.g., UE 10) monitors a PDDCH for data (e.g., traffic data, or other suitable information). In one example embodiment, since the DRX pattern-2 may correspond to the DRX RRC Connected state, the power consumption of the UE 10 when utilizing the DRX pattern-2 may be more than the power consumption of the UE 10 in an instance in which the UE 10 utilizes DRX pattern-1 (e.g., in which the power consumption may be analogous to an RRC IDLE state). Also, in some example embodiments, since the UE 10 may route or offload traffic mainly on the local eNB 110 of the local area cell 111, the UE 10 may utilize the DRX-pattern 2 (e.g., DRX RRC Connected state) in the local area cell 111.

In some example embodiments, the MME 78 may inform macro eNB 100 about the connection or mapping relationship of a Cell Radio Network Temporary Identifier C-RNTI and UE ID which the macro eNB 100 may utilize to calculate a paging frame (PF) and/or paging occasion (PO) for the dual connection UE 10, as described more fully below.

Moreover, in some example embodiments, additional enhanced mechanisms may be utilized to bring the UE 10 to active time under certain conditions as described more fully below.

To configure the power savings mode in the macro cell 101, the macro eNB 100 may indicate a predefined fixed DRX pattern (e.g., DRX pattern-1) by utilizing an indicator (e.g., a one bit indicator) in a DRX configuration information element (IE). The macro eNB 100 may send the DRX configuration IE to the local eNB 110. In this regard, in response to analyzing the received DRX configuration IE, the UE 10 may align its paging occasion, or a time period of the paging occasion, and a DRX active time together to enable the UE 10 to be in active time in its paging occasion in the macro cell 101. In other words, the macro eNB 100 may align a DRX active time with the paging occasion, or a time period of the paging occasion, such that the DRX active time corresponds to or matches the time period of the paging occasion.

In another example embodiment, the macro eNB 100 may configure the DRX pattern (e.g., DRX pattern-1) according to the paging occasion of the UE 10 by configuring an on_durationTimer as 1 Physical Downlink Control Channel (PDCCH) Subframe (PSF) and may control the related DRX cycle and offset to make the DRX cycle match the paging occasion, or a time period of the paging occasion, of the UE 10 in the macro cell 101.

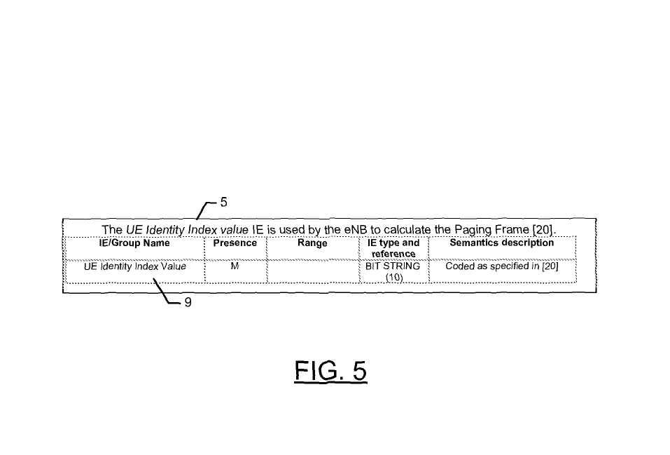

However, in an example embodiment, the macro eNB 100 may be able to facilitate alignment of the active DRX time and the paging occasion of the UE 10. In this regard, in response to detecting that the UE 10 establishes dual connection with the macro eNB 100 and the local eNB 110, the MME 78 may inform the macro eNB 100 of a UE ID (e.g., an International Mobile Subscriber Identity (IMSI) value) of the UE 10 that is also associated with a C-RNTI of the UE 10. As such, the macro eNB 100 may receive a one-to-one map between a UE ID and C-RNTI of the UE 10 in a UE Identity Index value IE 5 shown in FIG. 5. The UE Identity Index value IE 5 may be sent from the MME 78 to the macro eNB 100. The macro eNB 100 may utilize the UE ID of the UE 10, associated with the C-RNTI of the UE mapped in the UE Identity Index Value 9 for example, to calculate the paging frame and/or the paging occasion of the UE 10. For instance, in one example embodiment, the processor 24 of the macro eNB 100 may calculate the paging occasion according to the following equation (1).

Paging Occasion=(IMSI div K)mod DRX Cycle Length+(n*DRX Cycle Length) (1)

1.1 where K=the number of available Secondary Common Control Physical Channels
(SCCPCHs) that carry a Paging Channel (PCH), and n=0, 1, 2, . . . .

In response to calculating the paging frame and/or paging occasion of the UE 10, the macro eNB 100 may send the UE 10 an indication requesting or instructing the UE 10 to align the active time of a DRX to the paging occasion and/or paging frame to enable the UE 10 to be in active time in its paging occasion in the macro cell 101. In this regard, the active DRX time of the UE 10 may be aligned with the subframe in which the UE 10 is assigned to be active to receive important information (e.g., paging information, system information in the paging occasion/paging subframe) in the macro cell 101. As such, the UE 10 may have efficient power consumption, in the macro cell 100, analogous to an RRC IDLE state in some example embodiments. It should be pointed out that during the dual connection, the UE 10 may be utilizing the DRX pattern-2 (e.g., DRX for the RRC Connected state) for the connection to the local eNB 110 of the local area cell 111 since the local eNB 110 may be providing traffic data to the UE 10.

Besides the fixed DRX pattern (e.g., DRX pattern-1), the UE 10 may have other immediate (important) information that it may need to transmit/receive to/from the macro eNB 110, including but not limited to, a measurement report, a handover command, and any other suitable information. As such, the macro eNB 110 may be able to handle some situations to bring/trigger the UE 10 into active time.

For example, in one example embodiment, the macro eNB 100 may utilize or communicate (e.g. via designated signalling etc.) with the local area cell 111 to bring the UE 10 into active time. In this regard, the macro eNB 110 may communicate with the local eNB 110 of the local area cell 111 to switch the DRX mode of the UE 10 from a power saving DRX mode (e.g., DRX pattern-1) to a normal backup DRX mode (e.g., DRX pattern-2 (e.g., DRX RRC Connected state).

As such, in response to the UE receiving a message or signalling from the local eNB 110, or an indication that a corresponding condition(s) is fulfilled in the local area cell 111, the local eNB 110 may instruct the UE 10 to utilize the normal DRX mode. In this regard, the UE 10 may enter active time and may utilize the normal backup DRX mode in macro cell 101. For instance, the local eNB 110 may send an indication to the UE 10 to instruct the UE 10 to switch to the normal DRX mode. An example of a condition(s) being fulfilled in the local area cell 111 may, but need not, relate to an amount of data for a macro link being more than a threshold or the local area link quality being below a predefined threshold or any other suitable condition(s).

A benefit of this solution may be flexibility in that network devices (e.g., macro eNB 100, local eNB 110) may control switching between two DRX configuration modes of the UE 10 freely depending on the amount of data to be communicated to the UE 10, system/network load, etc.

In another example embodiment, in an instance in which important information including, but not limited to, handover related information, may need to be routed via the macro eNB 100 to the UE 10, the UE 10 may be triggered to enter active time of a normal DRX configuration in an instance in which the UE 10 has a predefined measurement report that may be provided to the macro eNB 100, as described more fully below.

Additionally, in one example embodiment, in response to the UE 10 detecting that a measured Reference Signal Received Power (RSRP) or Reference Signal Received Quality (RSRQ) of the UE 10 is below some predetermined threshold in the local area cell 111, the UE 10 may switch from the DRX pattern-1 and utilize the normal backup DRX configuration (e.g., DRX pattern-2) in the macro cell 101. In this regard, the UE 10 may switch to using the normal backup DRX configuration since the UE 10 detected the RSRP/RSRQ to be below the predetermined threshold which may denote that the connection of the UE 10 with the local area cell 110 is deteriorating and is of low quality such that the UE 10 should utilize the macro eNB 100 for traffic data, etc.

As described above, in one example embodiment, in an instance in which the UE 10 determines that it has a measurement report to send to the macro eNB 100, the UE 10 may switch from the DRX pattern-1 on the macro cell 101 and may enter active time by using the normal backup DRX configuration (e.g., DRX pattern-2 (e.g., DRX RRC Connected state)). In this regard, the UE 10 may generate a scheduling request (SR) and may send (e.g., in predefined signaling) the measurement report to the macro eNB 100 via a Physical Random Access Channel (PRACH). In some example embodiments, the macro eNB 100 may send a handover command to the UE 10 in response to receipt of the measurement report from the UE 10.

In addition, other actions may be detected by the UE 10 to trigger the UE 10 to switch from the DRX pattern-1 in macro cell 101 and utilize the normal backup DRX configuration to enter active time in an instance in which other important information may need to be routed via macro cell 101.

In another example embodiment, the macro eNB 100 may utilize the local eNB 110 of the local area cell 111 to forward important signaling information such as, for example, non-access stratum (NAS) information and any other suitable information to the UE 10. For instance, the signaling information may, for example, relate to a measurement report, or other suitable information, which may be forwarded by the local area eNB 110 to the UE 10 with NAS information. In this regard, in an example embodiment, since the local area cell 111 may have a better radio condition and better connection with the UE 10, the macro eNB 100 may communicate with the local eNB 110 of the local area cell 111 and request the local eNB 110 to forward signaling information such as, for example, NAS information, or any other suitable information, received from the macro eNB 110 to UE 10. In this manner, the UE 10 may continue to utilize the DRX pattern-1 in the macro cell 101.

In an example embodiment, since the macro eNB 100 may utilize the local eNB 110 to forward information to the UE 10 on its behalf, the UE 10 may not necessarily need to change from the DRX pattern-1 to the normal DRX configuration (e.g., DRX pattern-2). In other words, the UE 10 may continue to utilize the DRX pattern-1 in the macro eNB 100 in some example embodiments in which the macro eNB 100 forwards information (e.g., signaling information) to the local eNB 111 to provide to the UE 10.

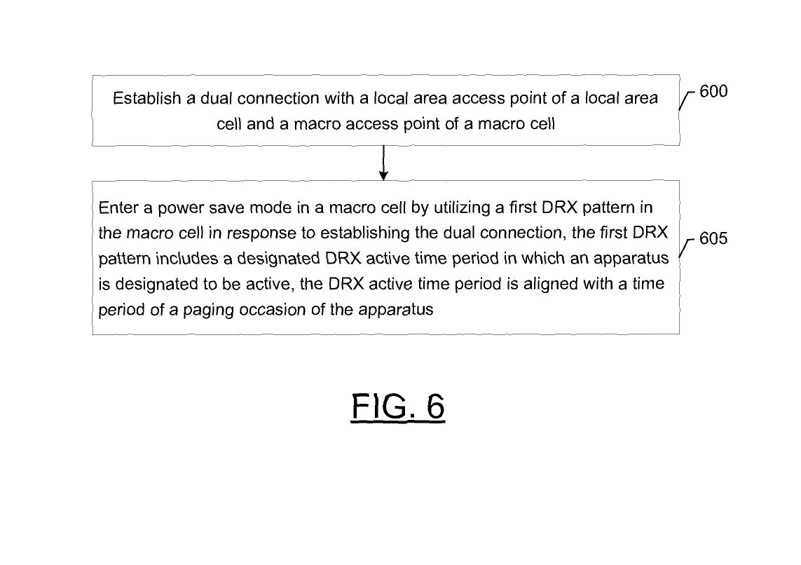

Referring now to FIG. 6, a flowchart of an example embodiment for minimizing power consumption in a macro cell is provided according to an example embodiment. At operation 600, an apparatus (e.g., UE 10) may include means, such as the processor 34, and/or the like, for establishing a dual connection with a local area access point (e.g., local eNB 110) of a local area cell (e.g., local area cell 111) and a macro access point (e.g., macro eNB 100) of a macro cell (e.g., macro cell 101). At operation 605, an apparatus (e.g., UE 10) may include means, such as the processor 34, and/or the like, for entering a power save mode in the macro cell by utilizing a first discontinuous reception (DRX) pattern (e.g., DRX pattern-1) in the macro cell in response to establishing the dual connection. The first DRX pattern may include a designated DRX active time period in which the apparatus (e.g., UE 10) is designated to be active. The DRX active time period is aligned with a time period of a paging occasion of the apparatus.

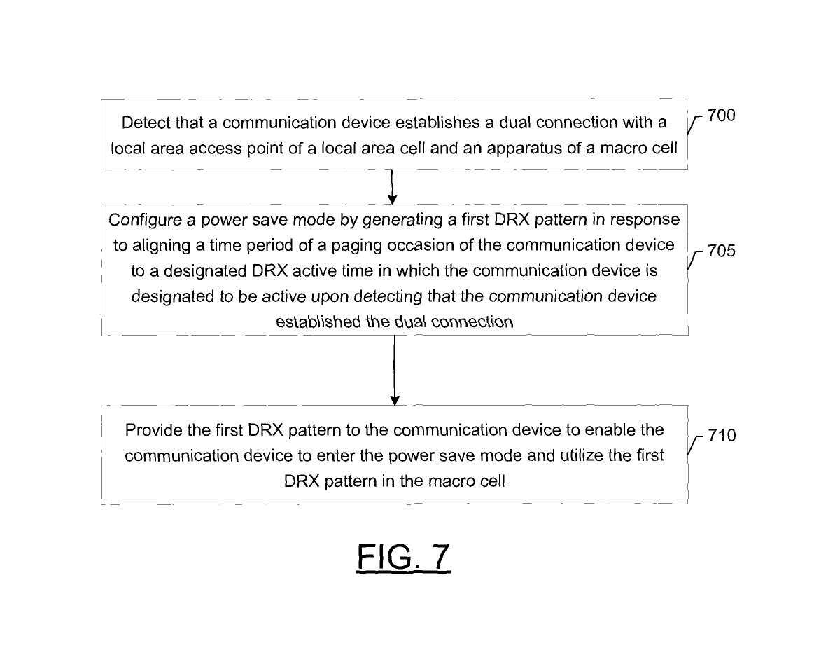

Referring now to FIG. 7, a flowchart of another example embodiment for minimizing power consumption in a macro cell is provided according to an example embodiment. At operation 700, an apparatus (e.g., macro eNB 100) may include means, such as the processor 24, and or the like, for detecting that a communication device (e.g., UE 10) establishes a dual connection with a local area access point (e.g., local eNB 110) of a local area cell (e.g., local area cell 111) and the apparatus (e.g., macro eNB 100) of a macro cell (e.g., macro cell 101).

At operation 705, an apparatus (e.g., macro eNB 100) may include means, such as the processor 24, and/or the like, for configuring a power save mode by generating a first discontinuous reception (DRX) pattern (e.g., DRX pattern-1) in response to aligning a time period of a paging occasion of the communication device (e.g., UE 10) to a designated, DRX active time in which the communication device is designated to be active upon detecting that the communication device (e.g., UE 10) established the dual connection with the local area cell and the macro cell.

At operation 710, an apparatus (e.g., macro eNB 100) may include means, such as the processor 24, and or the like, for providing the first DRX pattern to the communication device (e.g., UE 10) to enable the communication device to enter the power save mode and utilize the first DRX pattern in the macro cell.

It should be pointed out that FIGS. 6 and 7 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 26, memory 36) and executed by a processor (e.g., processor 24, processor 34). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 6 and 7 above may comprise a processor (e.g., the processor 24, the processor 34) configured to perform some or each of the operations (600-605, 700-710) described above. The processor may, for example, be configured to perform the operations (600-605, 700-710) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (600-605, 700-710) may comprise, for example, the processor 24 (e.g., as means for performing any of the operations described above), the processor 34 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
establishing a dual connection with a local area access point of a local area cell and a macro access point of a macro cell; and
entering a power save mode in a macro cell by utilizing a first discontinuous reception (DRX) pattern in the macro cell in response to the establishing of the dual connection, the first DRX pattern comprises a designated DRX active time period in which a communication device is designated to be active, the DRX active time period is aligned with a time period of a paging occasion of the communication device.

2. The method of claim 1, wherein:
the DRX active time period is aligned with a time period of a paging occasion such that the DRX active time period corresponds to, or matches, the time period of the paging occasion.

3. The method of claim 1, wherein the time period of the paging occasion comprises a designated time period in which the communication device monitors one or more paging messages received from the macro access point.

4. The method of claim 1, further comprising:
utilizing a second DRX pattern in the local area cell during the dual connection in which the second DRX pattern specifies at least one time period that the communication device is assigned to monitor a Physical Downlink Control Channel for data.

5. The method of claim 4, wherein the second DRX pattern comprises a DRX Radio Resource Control (RRC) Connected state.

6. The method of claim 1, wherein:
the DRX pattern is aligned with the paging occasion by the macro access point in response to the macro access point receiving an identifier, corresponding to the communication device, from a Mobility Management Entity, the identifier is utilized, in part, to calculate the paging occasion and a paging frame for the communication device.

7. The method of claim 1, wherein prior to entering the power save mode the method further comprises:
receiving an indication from the macro access point to align the time period of the paging occasion with the DRX active time period.

8-15. (canceled)

16. An apparatus comprising:
at least one processor; and
at least one memory including computer program code, wherein the at least one memory and the computer program code are configured to, with the at least one processor, cause the apparatus to at least perform:
establish a dual connection with a local area access point of a local area cell and a macro access point of a macro cell; and
enter a power save mode in a macro cell by utilizing a first discontinuous reception (DRX) pattern in the macro cell in response to the establishing of the dual connection, the first DRX pattern comprises a designated DRX active time period in which the apparatus is designated to be active, the DRX active time period is aligned with a time period of a paging occasion of the apparatus.

17. The apparatus of claim 16, wherein:
the DRX active time period is aligned with a time period of a paging occasion such that the DRX active time period corresponds to, or matches, the time period of the paging occasion.

18. The apparatus of claim 16, wherein the time period of the paging occasion comprises a designated time period in which the apparatus monitors one or more paging messages received from the macro access point.

19. The apparatus of claim any 16, wherein the memory and the computer program code are configured to, with the processor, cause the apparatus to:
utilize a second DRX pattern in the local area cell during the dual connection in which the second DRX pattern specifies at least one time period that the apparatus is assigned to monitor a Physical Downlink Control Channel for data.

20. The apparatus of claim 19, wherein the second DRX pattern comprises a DRX Radio Resource Control (RRC) Connected State.

21. The apparatus of claim 16, wherein:
the DRX pattern is aligned with the paging occasion by the macro access point in response to the macro access point receiving an identifier, corresponding to the apparatus, from a Mobility Management Entity, the identifier is utilized, in part, to calculate the paging occasion and a paging frame for the apparatus.

22. The apparatus of claim 16, wherein prior to enter the power save mode the memory and the computer program code are configured to, with the processor, cause the apparatus to:
receive an indication from the macro access point to align the time period of the paging occasion with the DRX active time period.

23. The apparatus of claim 16, wherein the indication comprises an indicator of a DRX configuration information element received from the macro access point.

24-59. (canceled)

60. An apparatus comprising:
at least one processor; and
at least one memory including computer program code, wherein the at least one memory and the computer program code are configured to, with the at least one processor, cause the apparatus to at least perform:
detect that a communication device establishes a dual connection with a local area access point of a local area cell and the apparatus of a macro cell;
configure a power save mode by generating a first discontinuous reception (DRX) pattern in, response to aligning a time period of a paging occasion of the communication device with a designated DRX active time in which the communication device is designated to be active upon detecting that the communication device established the dual connection; and
enable provision of the first DRX pattern to the communication device to enable the communication device to enter the power save mode and utilize the first DRX pattern in the macro cell.

61. The apparatus of claim 60, wherein the memory and the computer program code are configured to, with the processor, cause the apparatus to:
perform the aligning by aligning further comprises aligning the time period of the paging occasion with the DRX active time such that the DRX active time period corresponds to, or matches, the time period of the paging occasion.

62. The apparatus of claim 60, wherein the memory and the computer program code are configured to, with the processor, cause the apparatus to:
enable provision by providing an indicator identifying the first DRX pattern in a DRX configuration information element to the communication device.

63. The apparatus of claim 60, wherein the memory and the computer program code are configured to, with the processor, cause the apparatus to:
configure the power save mode by configuring an on duration timer as a Physical Downlink Control Channel (PDCCH) subframe (PSF) and control a corresponding DRX cycle and offset to cause the DRX cycle and offset to match the paging occasion.

64. The apparatus of claim 60, wherein prior to configure the power save mode the memory and the computer program code are configured to, with the processor, cause the apparatus to:
receive at least one identifier corresponding to the communication device from a Mobility Management Entity; and
calculate the paging occasion or a paging frame based in part on utilizing the identifier of the communication device to determine the designated DRX active time.

65-82. (canceled)
